(19) United States
(12) Patent Application Publication
(10) Pub. No.: US 2007/0172717 A1
(43) Pub. Date: Jul. 26, 2007

(54) FUEL CELL DEVICE

(76) Inventors: TSANG-MING CHANG, Taipei (TW); Chih-Jung Kao, Taipei (TW); Chun-Wei Pan, Taipei (TW); Hsi-Ming Shu, Taipei (TW); Wei-Li Huang, Taipei (TW)

Correspondence Address: G. LINK CO., LTD., 3550 BELL ROAD, MINOOKA, IL, 60447, US

(21) Appl. No.: 11/624,871

(22) Filed: Jan. 19, 2007

(30) Foreign Application Priority Data
Jan. 20, 2006 (TW) 095201323

(51) Int. Cl. H01M 8/02; H01M 8/10

(52) U.S. Cl. 429/38; 429/32

(57) ABSTRACT

The present invention is a fuel cell device, which at least comprises: at least one membrane electrode assembly, in which the membrane electrode assembly at least comprises: an anode electrode, a proton exchange membrane, and a cathode electrode; and, at least one double-sided flow board, which is configured on one side of the membrane electrode assembly, and the double-sided flow board employs a wave structure.

### FIELD OF THE INVENTION

The present invention relates to a fuel cell, and particularly to a fuel cell device comprising double-sided flow board.

### BACKGROUND OF THE INVENT ION

Fuel cell is a power generation device by directly converting the chemical energy stored in fuel and oxidant into electric energy through electrode reaction. There are a lot of types of fuel cell with various classification methods. Differentiating by the characteristics of proton exchange membrane, there are five different types of proton exchange membrane fuel cell, i.e. alkaline fuel cell, phosphoric acid fuel cell, proton exchange membrane fuel cell, molten carbonate fuel cell, and solid oxide fuel cell.

In the conventional fuel cell structure, the flow boards are placed at both sides of the membrane electrode assembly (MEA), and are made of the material with high conductivity, high strength, easy-to-fabricate, light weighted, and cost effective features. Currently, the material for flow board is graphite, aluminum, and stainless steel, most commonly graphite. The flow board is fabricated with channels as the passage supplying fuel and gas, so the reactant could reach the diffusion layer through the channel, and enter the reaction layer joining the reaction. Moreover, the flow board also has the function for conducting electric current, so the current generated by the reaction could be employed. Thus, the flow board with current collection function could also be referred as a bipolar board.

However, the conventional flow board (such as graphite plate) was normally made with single-side channel design, and had the shortcomings for too large volume, not light weighted, poor electric conductivity. The conventional fuel cell stack was stacked with such kind of heavy single-side flow boards, so the total volume and weight of fuel cell stack was doubled, which is not convenient for integrating with portable consumer electronic products, and only provides limited overall electricity collection capability.

### SUMMARY OF INVENTION

The main object of the present invention is to provide a fuel cell device, which could not only greatly reduce the volume and weight for the fuel cell body, but also improve the current collection function of the flow board.

To this end, the present invention provides a fuel cell device, which at least comprises: at least one membrane electrode assembly, in which the membrane electrode assembly at least comprises: an anode electrode, a proton exchange membrane, and a cathode electrode; at least one double-sided flow board, which is configured at one side of the membrane electrode assembly, in which the double-sided flow board employs a wave structure.

### BRIEF DESCRIPTION OF DRAWINGS

The above objective and advantages of the present invention will become more apparent with reference to the appended drawings wherein:

FIG. 1 is an elevation diagram for the basic portion of one embodiment for the fuel cell device according to the present invention;

FIG. 2A is an elevation diagram for the basic portion of another embodiment for the fuel cell device according to the present invention;

FIG. 2B is an exploded diagram for FIG. 2A according to the present invention;

FIG. 3A is an elevation diagram for the basic portion of further embodiment for the fuel cell device according to the present invention;

FIG. 3B is an exploded diagram for FIG. 3A according to the present invention;

FIG. 4A is a cross-sectional diagram for double-sided flow board used by the fuel cell device according to the present invention;

FIG. 4B is a cross-sectional diagram for a varied embodiment for double-sided flow board of FIG. 4A; and

FIG. 5 is an exploded diagram for the basic portion of a varied embodiment for the fuel cell device in FIG. 2A.

### DETAILED DESCRIPTION OF THE INVENTION

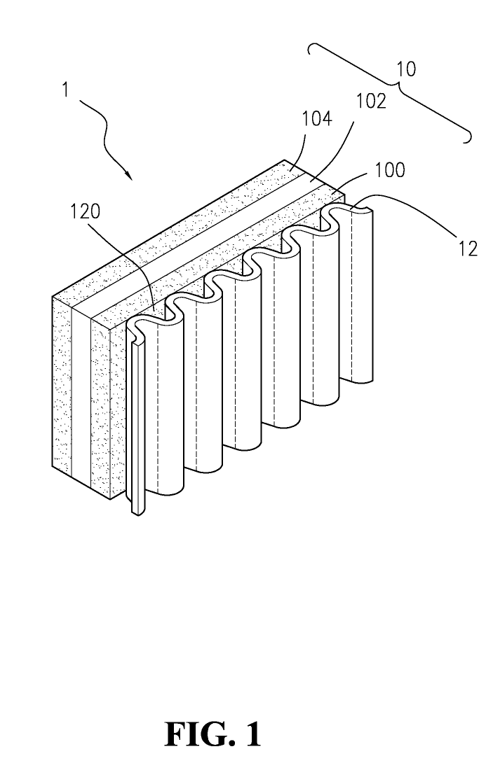

FIG. 1 shows an elevation diagram for the basic portion of an embodiment for the fuel cell device according to the present invention. As shown in FIG. 1, the fuel cell device 1 according to the present invention is a single fuel cell, which at least comprises: a membrane electrode assembly 10, a double-sided flow board 12; wherein, the membrane electrode assembly 10 at least comprises: an anode electrode 100, a proton exchange membrane 102, and a cathode electrode 104. The double-sided flow board 12 is configured at one side of the membrane electrode assembly 10, and employs a wave structure. As shown in FIG. 1, the fuel cell device according to the present invention employs a supply mechanism to make the fuel conducting electrochemical reaction with the membrane electrode assembly 10 through the flow channels 120 to generate the electrical power.

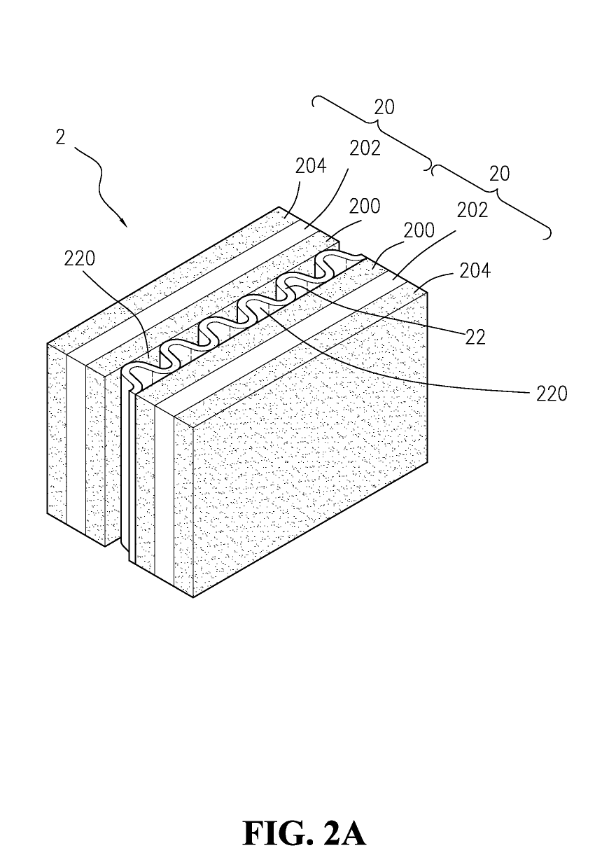

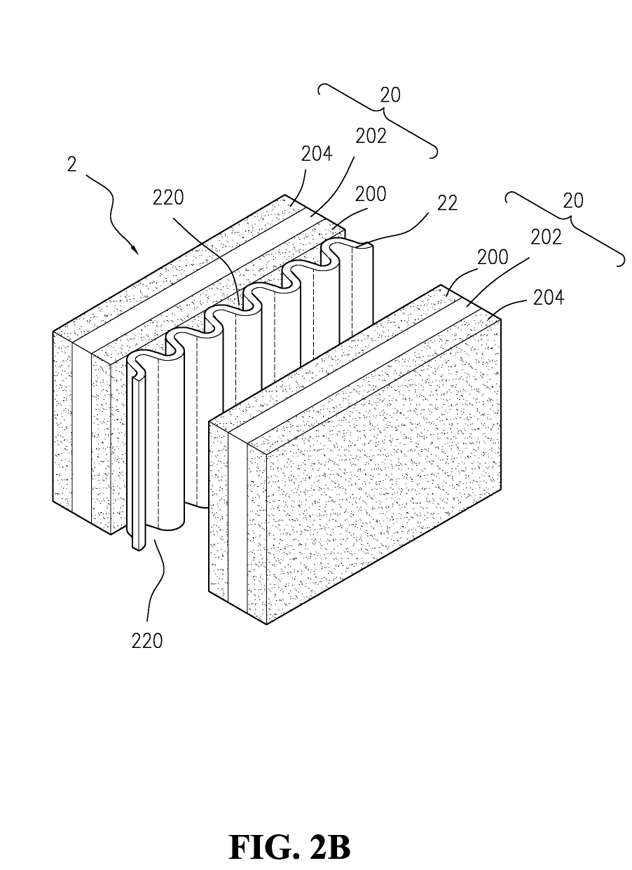

FIG. 2A is an elevation diagram for the basic portion of another embodiment for the fuel cell device according to the present invention. FIG. 2B is an exploded diagram of FIG. 2A according to the present invention. As shown in FIG. 2A and FIG. 2B, the fuel cell device 2 according to the present invention is a fuel cell stack, which at least comprises: these membrane electrode assemblies 20, a double-sided flow board 22; wherein, each of the membrane electrode assembly 20 at least comprises: an anode electrode 200, a proton exchange membrane 202, and a cathode electrode 204. The double-sided flow board 22 is configured at one side of these membrane electrode assemblies 20, and particularly configured between these anode electrodes 200 of these membrane electrode assemblies 20, and the double-sided flow board 22 employs a wave structure. Certainly, the double-sided flow board 22 in the fuel cell device 2 according to the present invention is only limited to be configured between these anode electrodes 200 of these membrane electrode assemblies 20, which could be also applied in various varied embodiments, such as configuring the double-sided flow board 22 between these cathode electrodes 204 of these membrane electrode assemblies 20, or configuring the double-sided flow board 22 between the anode electrode 200 and the cathode electrode 204 of these membrane electrode assemblies 20. Moreover, as shown in FIG. 2A, the fuel cell device according to the present invention could employ a supply mechanism to make the fuel conducting electrochemical reaction with these membrane electrode assemblies 20 through the flow channels 220 to generate the electrical power.

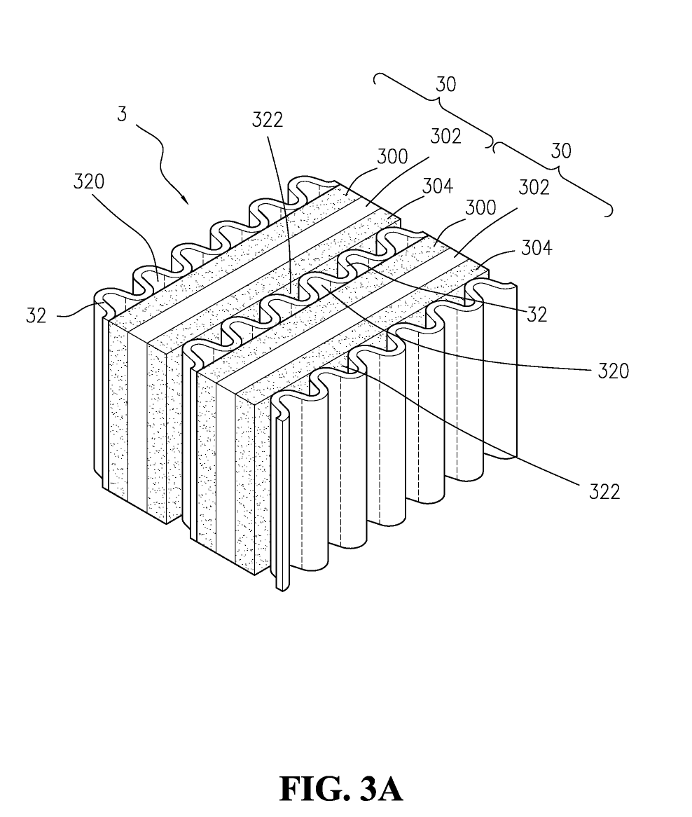

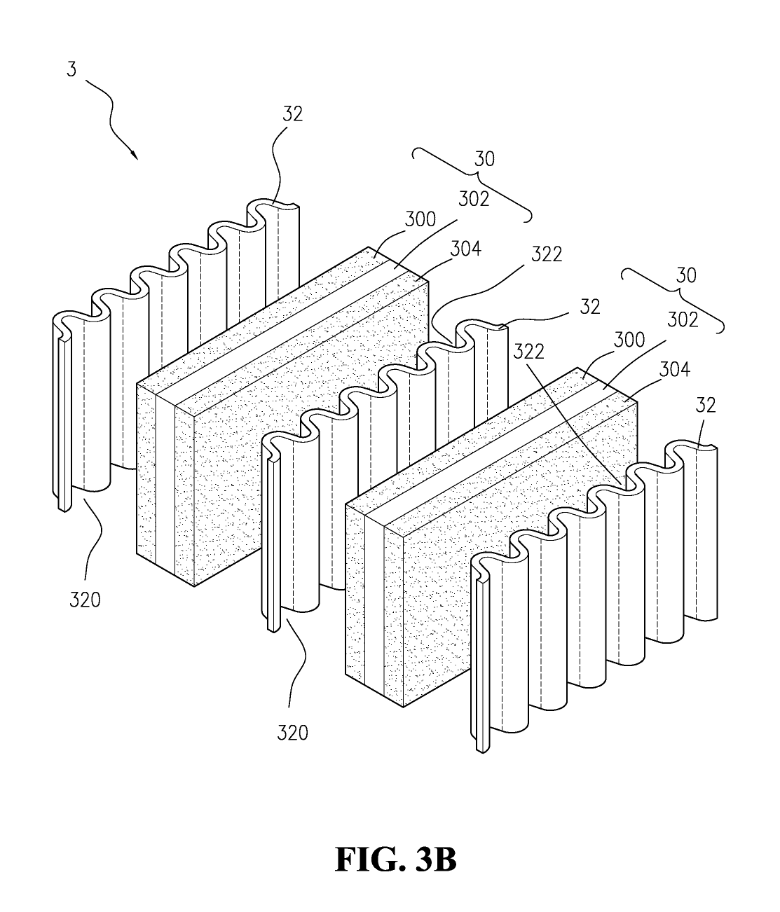

FIG. 3A is an elevation diagram for the basic portion of further embodiment of the fuel cell device according to the present invention. FIG. 3B is an exploded diagram for FIG. 3A according to the present invention. As shown in FIG. 3A and FIG. 3B, the fuel cell device 3 is a fuel cell stack, which at least comprises: these membrane electrode assemblies 30, and these double-sided flow boards 32: wherein, these membrane electrode assemblies 30 are configured between these double-sided flow boards 32, which at least comprise: anode electrodes 300, proton exchange membranes 302, and cathode electrodes 304. Moreover, these double-sided flow boards 32 employ a wave structure. As shown in FIG. 3A, the fuel cell device according to the present invention employs a supply mechanism to make the fuel or air conducting electrochemical reaction with these membrane electrode assemblies 30 through the flow channels 320 or the flow channels 322 to generate the electrical power.

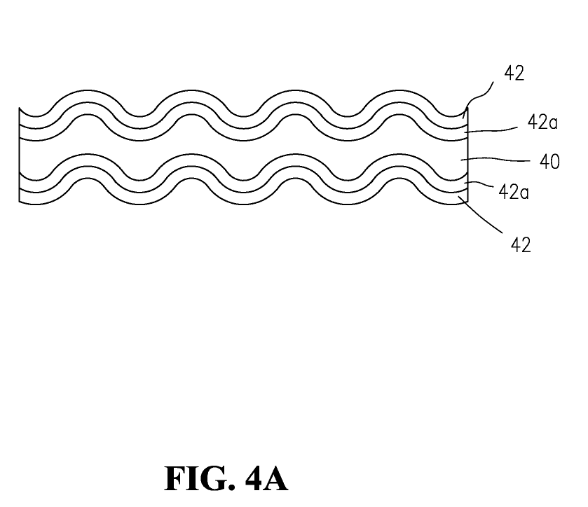

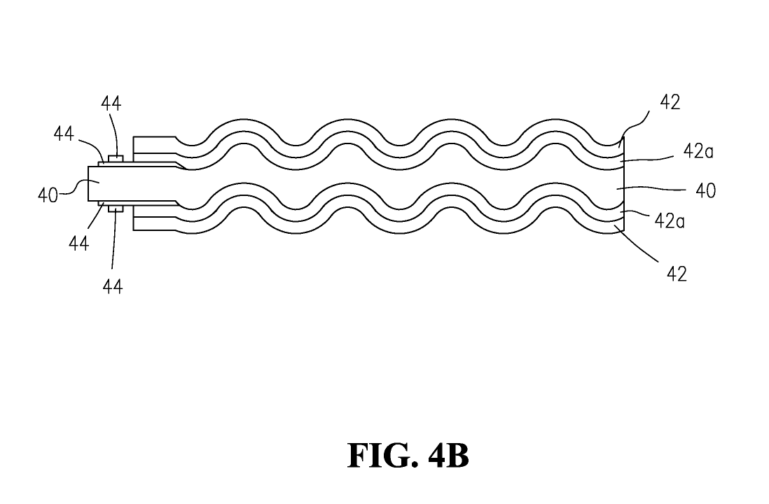

FIG. 4A is a cross-sectional diagram for double-sided flow boards 12, 22, 32 used by the fuel cell device according to the present invention. As shown in FIG. 4A, the double-sided flow boards 12, 22, 32 used in the present invention comprise: a substrate 40, which includes at least one channel structure; wherein, these configured locations for these channel structures are associated with the configured locations for these membrane electrode assemblies 10, 20, 30. As shown in FIG. 4A, the channel structure is a wave structure. These current collection sheets 42 are made of conductive material, and these current collection sheets 42 are covered over these channel structures of substrate 40, and these electricity collection sheets 42 are fixed with the substrate 40. As shown in FIG. 4A, these current collection sheets 42 employ the same wave structure. For the material selection, the substrate 40 could be chosen from one of anti-chemical non-conductive engineering plastic substrate, plastic carbon substrate, FR4 substrate, FR5 substrate, epoxy resin substrate, glass fiber substrate, ceramic substrate, polymer plastic substrate, and composite material substrate, and the material for the current collection sheet 42 could be a material with high conductivity, and the surface should be treated for anti-erosion and/or anti-acid, or should be provided with anti-chemical metal material (such as stainless steel, titanium, gold, graphite, carbon metal composite, etc.). Furthermore, the current collection sheet 42 could further comprise a metal layer 42a, which could be formed on the surface of the current collection sheet 42 with sputtering or spraying process, in which the material for the metal layer 42a could be chosen from one of gold, copper, silver, carbon, high conductivity metal.

FIG. 4B is a cross-sectional diagram for a varied embodiment of the double-sided flow board of FIG. 4A. As shown in FIG. 4B, the substrate 40 could be further configured with at least one circuit component 44. The circuit component 44 could be a circuitry, and particularly a printed circuitry, wherein the circuit component 44 is electrically connected with the current collection sheets 42.

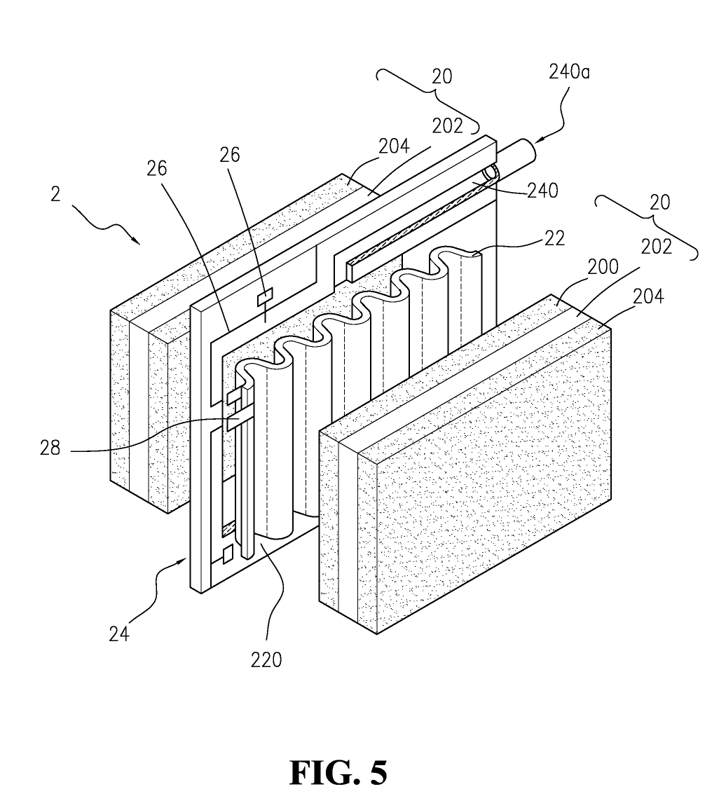

FIG. 5 is an exploded diagram for the basic portion of a varied embodiment for the fuel cell device of FIG. 2A. As shown in FIG. 5, the fuel cell device 2 according to the present invention further comprises: a substrate 24, which includes at least one hollow portion, in which the configured locations for these hollow portions are associated with the configured locations for these membrane electrode assemblies 20, and make these membrane electrode assemblies 20 and double-sided flow boards 22 tightly pressed onto the substrate 24. Moreover, the substrate 24 could be further configured with at least one circuit component 26, and the circuit component 26 could be a circuitry, and particularly a printed circuitry; wherein, the circuit component 26 could be contacted with the lead 28, and electrically connected with these current collection sheets 42 of the double-sided flow boards 22, so that these current collection sheets 42 could be electrically connected as a cascaded and/or parallel circuit through the circuitry. Thus, each power generation unit of the fuel cell stack could be linked together. For the fuel supply mechanism for the fuel cell device 2 according to the present invention, it could be embodied with the channels 240 configured on the substrate 24, Firstly, the fuel is injected into the inlet 240a; next, the fuel will be transported along the channels 240; finally, flowing to the flow channels 220, so the fuel could be conducted with electrochemical reaction with these membrane electrode assemblies 20 to generate the electrical power.

The fuel cell device according to the present invention is a fuel cell employing liquid fuel (such as methanol), or a fuel cell employing gas fuel, or a fuel cell employing solid fuel. Finally, the features and effects according to the present invention are concluded below:

1. The fuel cell device according to the present invention employs a double-sided flow board with wave structure, which could greatly reduce the overall volume and weight of the fuel cell (especially fuel cell stack), and could be convenient for integrating fuel cell to portable consumer electronic product;
2. The fuel cell device according to the present invention employs the stiffness of the plate body of the double-sided flow board to fabricate the electricity collection sheet with extremely slim structure, so as to greatly reduce the volume and weight of the fuel cell;
3. The double-sided flow board used in the fuel cell device according to the present invention could employs the anti-chemical non-conductive engineering plastic material as the plate body, and be configured with electricity collection sheets made of conductive material, so as not only to make the fuel cell with lighter weight and the convenience of portability, but also to make the double-sided flow board provided with excellent electricity collection function; and
4. The double-sided flow board used in the fuel cell device according to the present invention could effectively prevent the damage to the surface of electricity collection sheet by the fuel (such as methanol) or electrochemical reaction product, and reduce the replacement rate.

The present invention has been described as above. However, the disclosed embodiments are not limiting the scope of the present invention. And, for the skilled in the art it is well appreciated that the change and modification without departing from the claims of the present invention should be within the scope of the present invention, and the protection scope of the present invention should be defined with the attached claims.

What is claimed is:

1. A fuel cell device, which at least comprises:
a plurality of double-sided flow boards, wherein each double-sided flow board employs a wave structure, and each double-sided flow board comprises:
a substrate, which comprises at least one channel structure, wherein the configured locations for these channel structures are associated with the configured locations for membrane electrode assemblies;
at least one current collection sheet, which is made of conductive material, and the current collection sheets are covered on the channel structures on the substrate, and the electricity collection sheets are fixed with the substrate;
the membrane electrode assemblies, each is disposed between the corresponding two double-sided flow boards, wherein each membrane electrode assembly at least comprises: an anode electrode, a proton exchange membrane, and a cathode electrode.

2. The fuel cell device of claim 1, wherein the fuel cell device is a fuel cell stack.

3. The fuel cell device of claim 1, wherein the channel structure is a wave structure.

4. The fuel cell device of claim 1, wherein the electricity collection sheet employs a wave structure.

5. The fuel cell device of claim 1, wherein the substrate is chosen one from anti-chemical non-conductive engineering plastic substrate, plastic carbon substrate, FR4 substrate, FR5 substrate, epoxy resin substrate, glass fiber substrate, ceramic substrate, polymer plastic substrate, and composite material substrate.

6. The fuel cell device of claim 1, wherein the material of the current collection sheet is chosen one from stainless steel, titanium, gold, graphite, carbon metal compound, and anti-chemical metal.

7. The fuel cell device of claim 1, wherein the current collection sheet is made of conductive material, and the surface is treated with anti-erosion and/or anti-acid.

8. The fuel cell device of claim 1, wherein the current collection sheet further comprises a metal layer, which is formed on the surface of the current collection sheet.

9. The fuel cell device of claim 8, wherein the material for the metal layer is chosen one from gold, copper silver, carbon, high conductivity metal.

10. The fuel cell device of claim 1, wherein the double-sided flow board further comprises at least one circuit component, which is disposed on the substrate.

11. The fuel cell device of claim 10, wherein the circuit component is a circuitry.

12. The fuel cell device of claim 11, wherein the circuitry is a printed circuitry, and electrically connected to the current collection sheets.
